(19) United States
(12) Patent Application Publication
(10) Pub. No.: US 2023/0358395 A1
(43) Pub. Date: Nov. 9, 2023

(54) BUOYANT APPARATUS

(71) Applicants: Melissa Carnahan, Indiana, PA (US); August Carnahan, Indiana, PA (US)

(72) Inventors: Melissa Carnahan, Indiana, PA (US); August Carnahan, Indiana, PA (US)

(21) Appl. No.: 18/311,543

(22) Filed: May 3, 2023

Related U.S. Application Data
(60) Provisional application No. 63/483,161, filed on Feb. 3, 2023.
(60) Provisional application No. 63/338,136, filed on May 4, 2022.

(51) Int. Cl. F21V 35/00

(52) U.S. Cl. CPC F21V 35/00

(57) ABSTRACT

Embodiments relate to a buoyant apparatus having a member made from a material and having a shape that exhibits buoyancy in a fluid. The member is configured to maintain an upright orientation when placed in or on the fluid and is sized to fit within a beverage container. In some embodiments, the member has a top with a dead-hole and a bottom with an indent. The apparatus can be placed in or on beverage contained within a beverage container such that the bottom spearheads the advance towards the beverage. The indent can form an air pocket and trap the air pocket within the indent when the buoyant apparatus is placed in or on the beverage. The air pocket can maintain or bias the buoyant apparatus in an upright orientation, the upright orientation including the dead-hole not making contact with the beverage or being biased away from the beverage.

### CROSS-REFERENCE TO RELATED APPLICATIONS

This patent application is related to and claims the benefit of U.S. provisional application no. 63/483,161, filed on Feb. 3, 2023 and U.S. provisional application no. 63/338,136, filed on May 4, 2022, the entire contents of each is incorporated by reference.

### FIELD OF THE INVENTION

Embodiments relate to a buoyant apparatus. It is contemplated for the buoyant apparatus to be placed in or on liquid (e.g., beverage) held in a container (e.g., beverage container) to serve as a tool, implement, embellishment, etc.

### BACKGROUND OF THE INVENTION

The existence of known wax-based substance that when placed in a liquid displaces more water by weight than the weight of the substance causing it to float. The disadvantage of this existing known substance is its lack of serving the purpose of being useful, profitable, and/or beneficial, especially through being able to perform several functions such as celebrating and creating memories, while providing space(s) for words, logos, advertisements, marketing and/or promotions. Therefore, what is needed are techniques that overcome the above-mentioned disadvantages.

### SUMMARY OF THE INVENTION

Embodiments can relate to a buoyant apparatus. The apparatus can include a member comprising a material and having a shape that exhibits buoyancy in a fluid (e.g., liquid, gas, etc.). The member can be configured to maintain an upright orientation when placed in or on the fluid. The member can be sized to fit within a beverage container.

It is contemplated for embodiments of the apparatus to be used in the field of activity related to people celebrating with a liquid beverage. Some embodiments can involve adding a buoyant apparatus configured to exhibit buoyancy (e.g., when placed in a fluid, the apparatus displaces more fluid by weight than the weight of the fluid, thereby causing the apparatus to float on or be suspended in the fluid) in liquid beverage contained within a beverage container. The buoyant apparatus can include a candle for example to allow for it to be used for the purposes of a celebration.

Embodiments of the buoyant apparatus can be made of and/or contain but not limited to a wax-based substance and/or a plastic matter object that may or may not contain a candle. The nature, identity, and character of embodiments disclosed herein relate to a buoyant apparatus to be placed in a liquid beverage that can serve the purpose of being useful and beneficial by helping people, through being able to perform several functions such as celebrating any/all occasions and creating memories, while providing space(s) for words, logos, advertisements, marketing and/or promotions for both non-licensing and licensing options.

An exemplary embodiment can relate to a buoyant apparatus. The buoyant apparatus can include a member, the member comprising a material and having a shape that exhibits buoyancy in a fluid. The member can be configured to maintain an upright orientation when placed in or on the fluid. The member can be sized to fit within a beverage container.

In some embodiments, the member can include a surface ornamentation.

In some embodiments, the fluid can be a liquid beverage.

In some embodiments, the buoyancy in the fluid can include floating on top of the fluid, partially submerged within the fluid, and/or fully submerged within the fluid but suspended within a volume of the fluid.

In some embodiments, the member can have a top with an apex, and the upright orientation includes an orientation in which the apex is not within the fluid.

In some embodiments, the member can have a top, and the top can include a dead-hole.

In some embodiments, the top can includes an apex, and the dead-hole can be located at or near the apex.

In some embodiments, the member can have a bottom, and the bottom can include an indent.

In some embodiments, the bottom can include a minima, and the indent can be located at or near the minima.

In some embodiments, the apparatus can include a buoy ring, a keel, a fin, a rudder, and/or an outrigger.

In some embodiments, at least a portion of the member can be weighted or include a weight.

In some embodiments, the member can comprise a wax-based material.

In some embodiments, the member can include a core and a coating.

In some embodiments, the core can comprise is rigid material, and the coating can comprises a material that is formable via a mold.

In some embodiments, the core can comprise plastic, and the coating can comprise wax-based material.

In some embodiments, the member can include a core and a coating. The member can have a top, and the top can include a dead-hole formed in the core and/or the coating.

In some embodiments, the member can include a core and a coating. The member can have a bottom, and the bottom can include an indent formed in the core and/or the coating.

In some embodiments, the apparatus can include an illumination device.

In some embodiments, the member can have a top, and the top can include a dead-hole. The top can include an apex, and the dead-hole can be located at or near the apex. The dead-hole can be configured to receive and retain an object.

In some embodiments, the object can be a candle.

An exemplary embodiment can relate to a method of using a buoyant apparatus. The apparatus can include a member having a top with a dead-hole and a bottom with an indent. The method can involve placing a buoyant apparatus in or on beverage contained within a beverage container such that the bottom spearheads the advance towards the beverage. The method can involve allowing the indent to form an air pocket and trap the air pocket within the indent when the buoyant apparatus is placed in or on the beverage. The air pocket can maintain or bias the buoyant apparatus in an upright orientation, the upright orientation including the dead-hole not making contact with the beverage or being biased away from the beverage.

In some embodiments, the method can involve using the buoyant apparatus to celebrate an occasion, create a memory, advertise or promote a product, and/or advertise or promote an event.

### BRIEF DESCRIPTION OF THE DRAWINGS

The above and other objects, aspects, features, advantages and possible applications of the present invention will be more apparent from the following more particular description thereof, presented in conjunction with the following drawings. For example, embodiments of the preset invention are illustrated by way of example and not limitation in the figures of the accompanying drawings in which like references indicate similar elements.

FIG. 1 shows an exemplary embodiment of the apparatus.

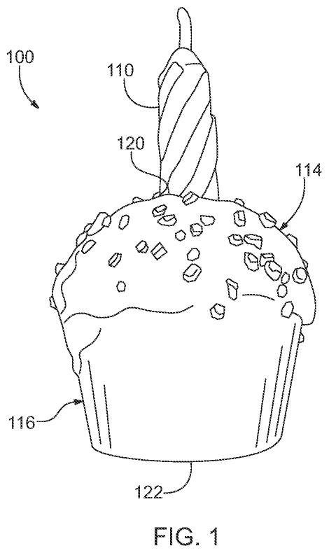

FIG. 2 shows an exemplary embodiment of the apparatus in a beverage container.

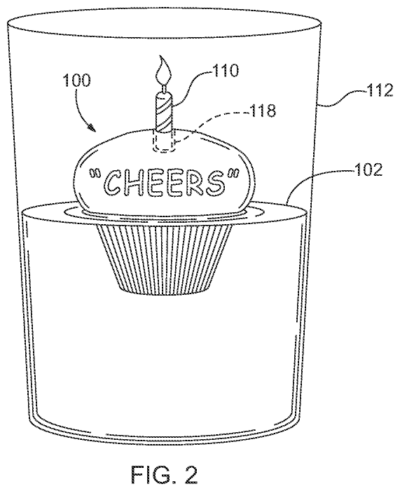

FIG. 3 shows an exemplary embodiment of the apparatus in a beverage container.

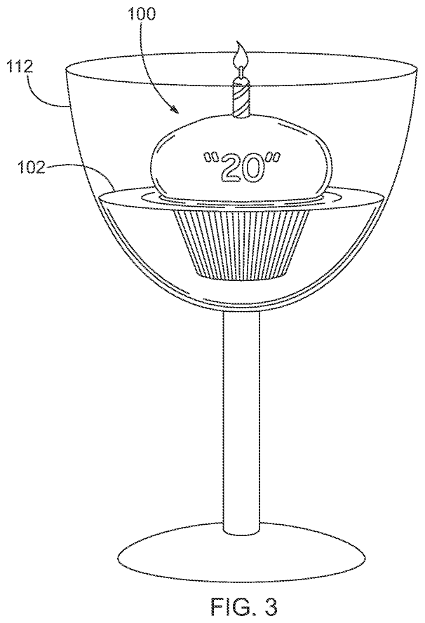

FIG. 4 shows an exemplary embodiment of the apparatus in a beverage container.

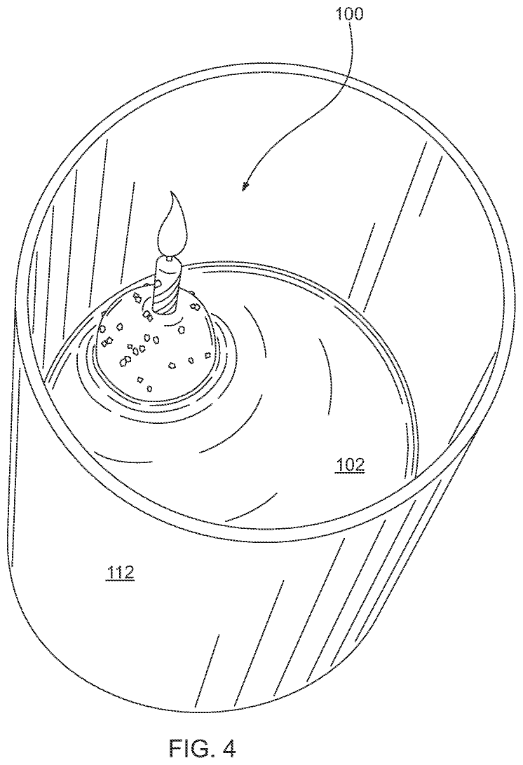

FIG. 5 shows an exemplary embodiment of the apparatus in a beverage container.

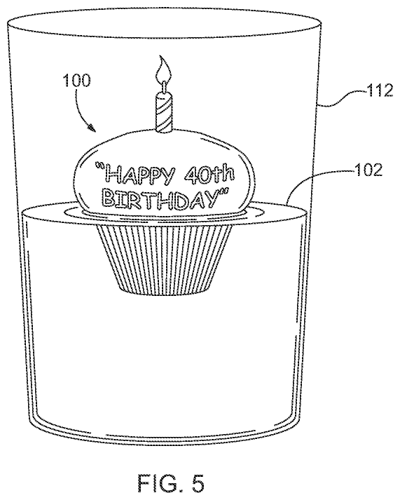

FIG. 6 shows an exemplary embodiment of the apparatus being used in an exemplary celebratory event.

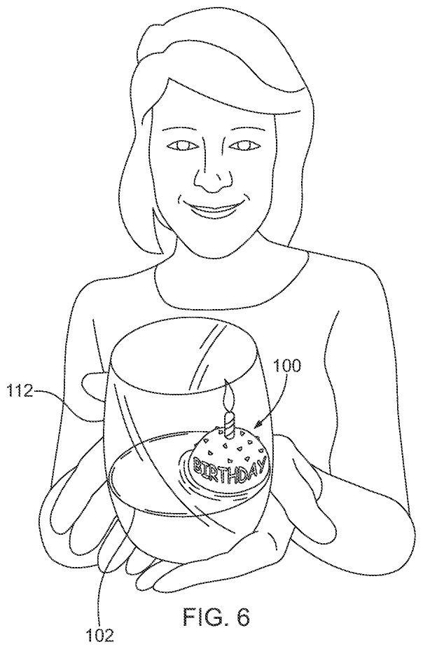

FIG. 7 shows an exemplary top view of an embodiment of the apparatus.

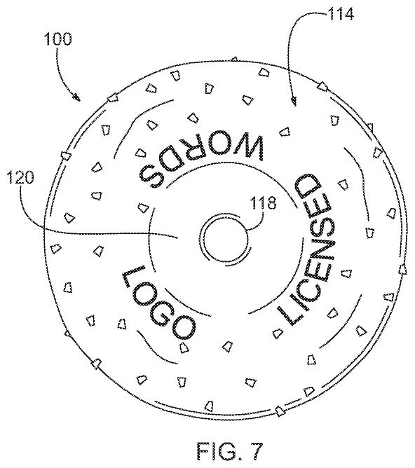

FIG. 8 shows an exemplary side view of an embodiment of the apparatus.

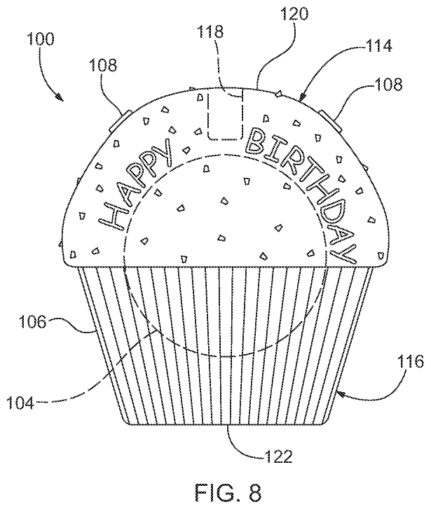

FIG. 9 shows an exemplary perspective view of an embodiment of the apparatus.

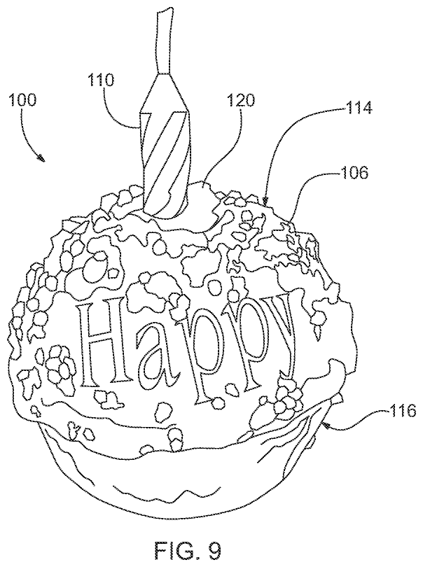

FIG. 10 shows an exemplary embodiment of the apparatus with an indent formed in a bottom of the apparatus.

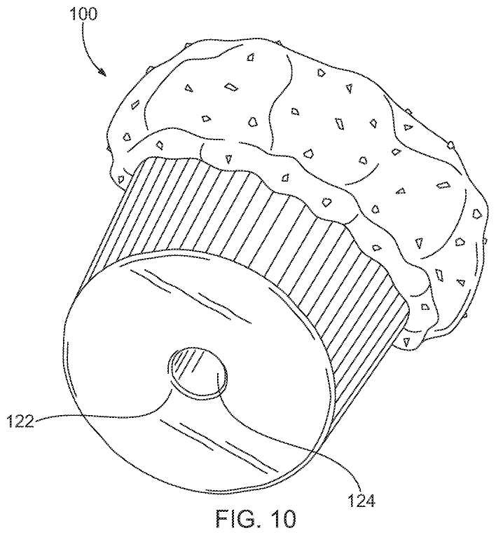

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Embodiments can relate to a buoyant apparatus 100. The buoyant apparatus 100 can be configured to exhibit buoyancy in a fluid 102, and thus the buoyant apparatus 100 can have a shape and be comprised of material having a density that allows it to exhibit a desired buoyancy in the fluid 102. The desired buoyancy can be a buoyance facilitating floating on top of the fluid 102, a buoyancy facilitating being partially submerged within the fluid 102, and/or a buoyancy facilitating being fully submerged within the fluid 102 but suspended within a volume of the fluid 102. Selecting a desired buoyancy depends on factors such as density of the buoyant apparatus 100, density of the fluid 102, weight displaced by the buoyant apparatus 100 (which can be influenced by the shape of the buoyant apparatus 100), etc. It is contemplated for the buoyant apparatus 100 to be used in or on fluids 102 comprising beverage 102 (e.g., water, juice, soft-drink, alcoholic beverage, etc.) contained within a beverage container 112 (e.g., glass, cup, wine glass, beer glass, etc.). Thus, the desired buoyancy can be selected based on one or more types of material properties of the anticipated beverage 102.

The buoyant apparatus 100 can be made from plastic, polymer, silicone, wax, wax-based material, ceramic, composite material, glass, metal, wood, epoxy, acrylic, resin, gel, glue, etc. As it is contemplated for the buoyant apparatus 100 to be used with beverage 102 (e.g., liquid designed for consumption), the material used to fabricate the buoyant apparatus 100 can be selected to be safe (e.g., non-toxic, non-poisonous, etc.), to not dissolve in the fluid 102, to not react with the fluid 102, to not absorb or adsorb the fluid 102, etc. The buoyant apparatus 100 can be made of a single material, plural materials, a composite of plural materials, etc. Some embodiments can include a coating. Some embodiments can include an inner material that may be toxic, will dissolve, etc. but is overlayed by a material that completely envelops and isolates the inner material, wherein the overlay is safe, does not dissolve, etc. This overlay can be a protective coating that seals, waterproofs, weatherproofs, etc. any portion of all of the apparatus 100.

It is contemplated for the buoyant apparatus 100 to be made from a rigid core 104 and be coated, or at least partially coated, with a coating 106. In some embodiments, this coating 106 can be the overlay. In other embodiments, the apparatus 100 can have a coating 106 and an overlay placed on top of the coating 106. The core 104 can provide a base structure for the buoyant apparatus 100. The base structure can provide rigidity, structural integrity, etc. for the buoyant apparatus 100. The coating 106 can provide ornamental as well as utility aspects for the buoyant apparatus 100. In an exemplary embodiment, the rigid core 104 can be a plastic material, but other materials can be used. The coating 106 can be a wax-based material, but other materials can be used. The coating 106 can be molded, shaped, colored, painted, etc. to provide features that serve ornamental and/or utility functions. In an exemplary embodiment, the plastic core 104 can be a spherical member, but other shapes can be used. The spherical member can be solid or hollow. The core 104 can be placed in a cavity of a mold, wherein the coating (e.g., wax-based material 106) can be poured into the mold. The wax-based material 106 can then be allowed to harden or forced to hardened (e.g., allow to cool, allow to cure via passage of time, applying heat to cure, applying ultra-violate light to cure, etc., depending on the type of coating used).

As another example, the buoyant apparatus 100 can be made solely of the core 104 (e.g., without a coating 106). As another example, the buoyant apparatus 100 can be made solely of the coating 106 (e.g., made of the wax-based material 106 without a rigid core 104). For instance, the buoyant apparatus 100 can be made by pouring the coating 106 in the mold and forming the buoyant apparatus 100 made entirely of the wax-based material 106.

The buoyant apparatus 100, or at least the coating 106 if one is used, can be transparent (e.g., to visible light), translucent (e.g., to visible light), colored via paint, impregnated with pigment, etc. In some embodiments, the buoyant apparatus 100, or at least the coating 106 if one is used, can include a layer disposed thereon or be impregnated with a substance such as fragrance, medicant, spice, artificial flavor, etc. that emits from the buoyant apparatus 100 when the buoyant apparatus 100 is placed in the fluid 102. The release can be via chemical potential reaction, via diffusion, etc. The release can be a controlled release. In some embodiment, the buoyant apparatus 100/coating 106, or at least a portion thereof, can be made of or include a shape memory material (e.g., polyurethane, polyvinylchloride, vulcanized rubber, monomer/parafifin wax, Ni-Tinol, etc.) configured to retain the substance but release the substance upon changing shape, changing lattice structure, etc. when exposed to the fluid 102. In some embodiments, the buoyant apparatus 100/coating 106 can be made of or include a material that fluorescences (e.g., polymer synthesized by polymerization of fluorescent functional monomers), phosphorescences, etc. when exposed to the fluid 102.

In some embodiments, the buoyant apparatus 100/coating 106 can include at least one illumination device 108 (e.g., light emitting diode (LED), such as an inorganic LED, organic LED, polymer LED, etc.). The illumination device 108 can be encapsulated (e.g., encapsulated in a polymer or other material) and connected to an electrical power source (e.g., micro battery) via an electrical switch. The switch can be actuated via a manual switching assembly by a user, via a shape memory switching assembly, etc.

In some embodiments, the core 104, top 114, and/or coating 106 can be shaped to provide an ornamental feature such as an embellishment, design, decor, etc. In an exemplary embodiment, the coating 106 is in a shape of a cupcake, but other ornamental shapes can be used. For instance, the mold can be structured to generate a cupcake shape such that the coating 106 forms into a cupcake upon exiting the mold. Other shapes can include a balloon, a star, a flower, an animal, a letter, a word, a phrase, a number, a year (e.g., for a new year celebration), etc. In addition, any portion of the core 104 and/or coating 106 (which can include the top 114) can have surface ornamentation to present a design, lettering, numbers, sprinkles, confetti, etc. For instance, the coating 106 can be in the shape of a cupcake and the top 114 can have letters reciting “HAPPY BIRTHDAY”. The bottom 116 can have a fluted design, for example. In addition, or in the alternative, the coating 106 and/or top 114 can have objects that are deigns, emblems, lettering, numbers, sprinkles, confetti, etc. formed therein during the molding process. For instance, objects can be introduced along with the coating 106 material such that when it hardens, the objects will be embedded therein.

In some embodiments, the core 104, top 114, and/or coating 106 can be shaped to provide a utility feature. For instance, at or near the top 114 can include at least one dead-hole 118 formation configured to receive and retain an object 110 (a candle, a toothpick, a toy, a party-favor, candy, garnishment, fruit, vegetable, etc.). The dead-hole 118 can be formed in the core 104, top 114, and/or coating 106. As another example, the side can include at least one apertured ring or collar, a clip, or other formation configured to receive and retain an object 110 (a candle, a straw, a toy, a party-favor, candy, garnishment, fruit, vegetable, etc.). There can be any number of dead-holes, apertured rings, etc., and it/they can be located anywhere in or on the buoyant apparatus 100.

In an exemplary embodiment, the buoyant apparatus 100 can be in a shape of a cupcake. The buoyant apparatus 100 can include a rigid core 104. The rigid core 104 can be made of plastic and may be in the shape of a hollow sphere. The rigid core 104 can provide rigidity and structural integrity to the buoyant apparatus 100, and in particular for the dome portion of the cupcake formation for the buoyant apparatus 100. The buoyant apparatus 100 can include a wax-based coating 106 formed via a mold that generates the cupcake ornamental shape. The buoyant apparatus 100 can include a top 114 (e.g., the dome portion of the cupcake) and a bottom 116 (e.g., the flat base of the cupcake). In some embodiments, the mold can be configured to generate a dead-hole 118 at the top 114 of the buoyant apparatus 100. Alternatively, the dead-hole 118 can be formed by drilling or boring out a portion of the coating 106 at the top 114. The dead-hole 118 can be sized (e.g., its diameter and profile) to receive and retain a candle 110. The retention of the candle 110 in the dead-hole 118 can be via an interference fit. In addition, or in the alternative, the candle 110 can be affixed (e.g., using a fastener, glue, adhesive, wax, etc.) in place.

When placed in a beverage container 112 having beverage 102 contained therein, the buoyant apparatus 100 is buoyed in and/or on the beverage 102. The buoyancy is selected such that most of the buoyant apparatus 100 can be above the fluid line and maintain the candle 110 above the fluid line. In use, the candle 110 can be lit, and the buoyant apparatus 100 is buoyed in the beverage 102 while a user handles the beverage container 112. The buoyant apparatus 100 is also buoyed in the beverage 102 as the user drinks from the beverage container 112. It is contemplated for the candle 110 to not be lit as the user drinks from the beverage container 112. For safety reasons it is recommended the candle 110 not be lit, and preferably for the apparatus 100 to be removed from the beverage container 112 before commencing in drinking. After use, the buoyant apparatus 100 can be removed, washed, and used again if desired. Alternatively, the buoyant apparatus 100 can be removed and disposed of

As noted herein, the buoyant apparatus 100 can be used to retain an object 110 such as a candle 110 for example. With the object 110 being a candle 110, it may beneficial for the buoyant apparatus 100 to maintain an upright orientation. It should be noted that the upright orientation may also be desired for other types of objects 110. An upright orientation is one in which an apex 120 of the top 114 remains out of the fluid 102 or is at least biased to do so. For instance, the dead-hole 118 can be located at or near the apex 120, and with the buoyant apparatus 100 configured to maintain an upright orientation, the candle 110 does not dip into the beverage 102 even when the user jostles the beverage container 112. This can be achieved by weighing the bottom 116 of the buoyant apparatus 100 (e.g., the bottom 116 of the buoyant apparatus 100 can include a weight attached thereto or formed therein, the bottom 116 is made of material that is denser relative to the top 114, etc.), forming at least one buoy ring about the bottom 116, forming at least one keel, fin, rudder, etc. on the bottom 116, forming at least one outrigger structure extending from a side, etc. While these structures can work and may be desirable in some embodiments, it may be preferred to maintain an upright orientation without adding extra weight, without extending the profile of the buoyant apparatus 100, and/or without detracting from the desired look and feel of the buoyant apparatus 100. For instance, adding a keel structure can detract from the ornamentality of it being a cupcake. This and the other formations can also detract from the elegance, allure, and usefulness of the buoyant apparatus 100 by taking up too much volume, adding cost, etc.

In some embodiments, the bottom 116 can include at least one indent 124 (e.g., a divot, crater, dead-hole, groove, etc.). The indent 124 can be a conical shape, a pyramidal shape, a hemispherical shape, a krater shape, a chytra shape, a hydria shape, a stamnos shape, etc. The indent 124 can be formed in the core 104 and/or the coating 106 (which can include the bottom 116). The indent 124 can be formed at or near the minima 122 (e.g., the lowest point) of the buoyant apparatus 100. There can be any number of indents 124, and it/they can be located anywhere in or on the buoyant apparatus 100. The indent 124 located at or near the minima 122 provides an upright orientation biasing for the buoyant apparatus 100. When placed in the beverage 102, the indent 124 facilitates trapping air so as to form an air pocket within the indent 124. This air pocket stabilizes the buoyant apparatus 100 and facilitates maintaining/biasing an upright orientation. In some embodiments, the air pocket can assist in adding buoyancy to the buoyant apparatus 100. The buoyant apparatus 100 can be tipped, rolled, yawed, pitched, etc., but the air pocket in the indent 124 located at or near the minima 122 biases it in an upright orientation so as to maintain or force the dead-hole 118 located at or near the apex 120 out of the fluid 102. The air pocket in the indent 124 can prevent a normal jostle of the beverage container 112 from dunking the dead-hole 118. A vigorous jostle might not prevent the dead-hole 118 from being dunked, but it can force the buoyant apparatus 100 upright after being dunked.

An exemplary use of an embodiment of the buoyant apparatus 100 can involve introducing a volume of beverage 102 in a beverage container 112. Placing the buoyant apparatus 100 in or on the beverage 102 such that the bottom 116 spearheads the advance towards the beverage 102. When placed in or on the beverage 102, the top 114 is facing out of the beverage 102 while the bottom 116 is submerged or partially submerged with the beverage 102 due to the buoyancy of the apparatus 100. The air pocket of the indent 124 maintains the buoyant apparatus 100 in an upright orientation even if the beverage container 112 is moved or jostled. If desired, the user can drink from the beverage container 112 while the buoyant apparatus 100 is floating inside; however, this is not recommended for safety reasons. If the buoyant apparatus 100 is designed to receive and retain a candle 110 in a dead-hole 118, a user can insert the candle 110 before placing the buoyant apparatus 100 in the beverage 102. The candle 110 can be lit, and the user can move or even slightly jostle the beverage container 112 without the buoyant apparatus 100 deviating from its biased upright orientation too much so as to cause the candle 110 to dunk into the beverage 102.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A buoyant apparatus, comprising:
a member, the member comprising a material and having a shape that exhibits buoyancy in a fluid;
wherein the member is configured to maintain an upright orientation when placed in or on the fluid; and
wherein the member is sized to fit within a beverage container.

2. The buoyant apparatus of claim 1, wherein the member includes a surface ornamentation.

3. The buoyant apparatus of claim 1, wherein the fluid is liquid beverage.

4. The buoyant apparatus of claim 1, wherein buoyancy in the fluid includes floating on top of the fluid, partially submerged within the fluid, and/or fully submerged within the fluid but suspended within a volume of the fluid.

5. The buoyant apparatus of claim 1, wherein the member has a top with an apex, and the upright orientation includes an orientation in which the apex is not within the fluid.

6. The buoyant apparatus of claim 1, wherein the member has a top, and the top includes a dead-hole.

7. The buoyant apparatus of claim 6, wherein the top includes an apex, and the dead-hole is located at or near the apex.

8. The buoyant apparatus of claim 1, wherein the member has a bottom, and the bottom includes an indent.

9. The buoyant apparatus of claim 8, wherein the bottom includes a minima, and the indent is located at or near the minima.

10. The buoyant apparatus of claim 1, further comprising a buoy ring, a keel, a fin, a rudder, and/or an outrigger.

11. The buoyant apparatus of claim 1, wherein at least a portion of the member is weighted or includes a weight.

12. The buoyant apparatus of claim 1, wherein the member comprises a wax-based material.

13. The buoyant apparatus of claim 1, wherein the member includes a core and a coating.

14. The buoyant apparatus of claim 13, wherein the core comprises is rigid material, and the coating comprises a material that is formable via a mold.

15. The buoyant apparatus of claim 13, wherein the core comprises plastic, and the coating comprises wax-based material.

16. The buoyant apparatus of claim 1, wherein:
the member includes a core and a coating; and
the member has a top, and the top includes a dead-hole formed in the core and/or the coating.

17. The buoyant apparatus of claim 1, wherein:
the member includes a core and a coating; and
the member has a bottom, and the bottom includes an indent formed in the core and/or the coating.

18. The buoyant apparatus of claim 1, further comprising an illumination device.

19. The buoyant apparatus of claim 1, wherein:
the member has a top, and the top includes a dead-hole;
the top includes an apex, and the dead-hole is located at or near the apex; and
the dead-hole is configured to receive and retain an object.

20. The buoyant apparatus of claim 19, wherein the object is a candle.

21. A method of using a buoyant apparatus comprising a member having a top with a dead-hole and a bottom with an indent, the method comprising:
placing a buoyant apparatus in or on beverage contained within a beverage container such that the bottom spearheads the advance towards the beverage;
allowing the indent to form an air pocket and trap the air pocket within the indent when the buoyant apparatus is placed in or on the beverage;
wherein the air pocket maintains or biases the buoyant apparatus in an upright orientation, the upright orientation including the dead-hole not making contact with the beverage or being biased away from the beverage.

22. The method of claim 21, further comprising:
using the buoyant apparatus to celebrate an occasion, create a memory, advertise or promote a product, and/or advertise or promote an event.
